(19) United States
(12) Patent Application Publication
(10) Pub. No.: US 2025/0074240 A1
(43) Pub. Date: Mar. 6, 2025

(54) VEHICLE CONTROL DEVICE

(71) Applicant: TOYOTA JIDOSHA KABUSHIKI KAISHA, Toyota-shi (JP)

(72) Inventor: Shinya ARAKI, Seto-shi (JP)

(73) Assignee: TOYOTA JIDOSHA KABUSHIKI KAISHA, Toyota-shi (JP)

(21) Appl. No.: 18/675,297

(22) Filed: May 28, 2024

(30) Foreign Application Priority Data
Sep. 4, 2023 (JP) 2023-143203

(51) Int. Cl. B60L 53/62; G06F 8/65

(52) U.S. Cl. CPC B60L 53/62; G06F 8/65; B60L 2270/40

(57) ABSTRACT

The vehicle control device detects an update request for the control program from the external server to the in-vehicle ECU while the in-vehicle battery is being charged by the external power source. The vehicle control device performs a process of prohibiting the in-vehicle ECU from executing the update while the vehicle is being charged at least in part when the request for the update is detected.

### CROSS-REFERENCE TO RELATED APPLICATION

This application claims priority to Japanese Patent Application No. 2023-143203 filed on Sep. 4, 2023, incorporated herein by reference in its entirety.

### BACKGROUND

### 1. Technical Field

The technology disclosed in the present specification relates to a vehicle control device.

### 2. Description of Related Art

Japanese Unexamined Patent Application Publication No. 2023-18875 (JP 2023-18875 A) discloses so-called On The Air (OTA) technology in which an update for a control program of an electronic control unit (ECU) installed in a vehicle is received from an external server by wireless communication.

### SUMMARY

When an update by OTA occurs during charging of a battery of the vehicle, power consumed due to the update increases. When the battery is being charged to a predetermined target SOC, for example, duration of the charging period will consequently be prolonged by an amount corresponding to the power consumed by the update.

A vehicle control device disclosed in the present specification is a vehicle control device that controls a vehicle. The vehicle includes a battery that is chargeable using an external power source, a communication unit that is communicable with an external server regarding various types of data by wireless communication, and an ECU that executes various types of control based on a control program stored in advance.

The vehicle control device is configured to execute processing of detecting a request for update with respect to the control program, from the external server to the ECU, during charging of the battery by the external power source.
The vehicle control device is configured to execute processing of prohibiting the ECU from executing the update during the charging, at least in part of situations in which the request for updating is detected.

The vehicle control device may be any of a variety of devices. The vehicle control device may be separate from or integrated with the vehicle. The vehicle control device may be, for example, a mobile terminal (e.g., a smartphone, a laptop PC, or a wearable device) of a user, or may be a control device (e.g., an ECU) installed in the vehicle.

According to the above configuration, the ECU can be prohibited from executing the update during charging. Prohibiting updating during charging enables a situation to be suppressed in which the charging time becomes longer, as compared to when executing updating during charging. Thus, the charging time of the vehicle can be optimized.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block-diagram of an OTA system 1;

FIG. 2 is a flowchart for explaining the contents of the update processing;

FIG. 3 is a flow chart for describing processing of calculating a remaining charging time according to the first embodiment; and

FIG. 4 is a flowchart for explaining a calculation processing of the remaining charging time in the second embodiment.

### DETAILED DESCRIPTION OF EMBODIMENTS

Additional features of the driver disclosed herein are listed below.

In the process of prohibiting ECU, the execution of the update may be prohibited when the urgency of the update is within a predetermined low-level.

According to the above-described configuration, it is possible to perform an update with a low degree of urgency after charging of the battery is completed. It is possible to suppress a situation in which the charging time becomes long.

The vehicle control device may further execute a process of calculating an update power amount consumed in the vehicle by the update and a required power amount for the battery thereafter, when the update is executed during the charging. The vehicle control device may further execute a process of calculating a remaining charging time required for charging the battery from the external power source, from the total amount of the updated power amount and the required power amount, by subtracting the charged power amount at the time of starting the charging of the battery. The vehicle control device may further execute a process of notifying the user of the calculated remaining charging time.

According to the above configuration, it is possible to notify the user of the remaining charging time required for charging the required power amount. It is possible to prompt the user to optimize the charging time.

The required power amount may be a required power amount for moving to a destination.

According to the above configuration, it is possible to optimize the charging time so as to charge the battery with the required power amount for moving to the destination.

The vehicle control device may determine whether or not the battery can be charged at the destination when the update is executed during the charging. When it is determined that charging at the destination is possible, the vehicle control device may calculate a required power amount for one way to the destination. In a case where it is determined that charging at the destination is impossible, the vehicle control device may calculate a required power amount for round trips to the destination.

According to the above configuration, it is possible to optimize the required power amount depending on whether or not the battery can be charged at the destination. It is possible to suppress a situation in which the power of the battery is insufficient in the middle of the round-trip route to the destination.

### Example 1

### Configuration of OTA System 1

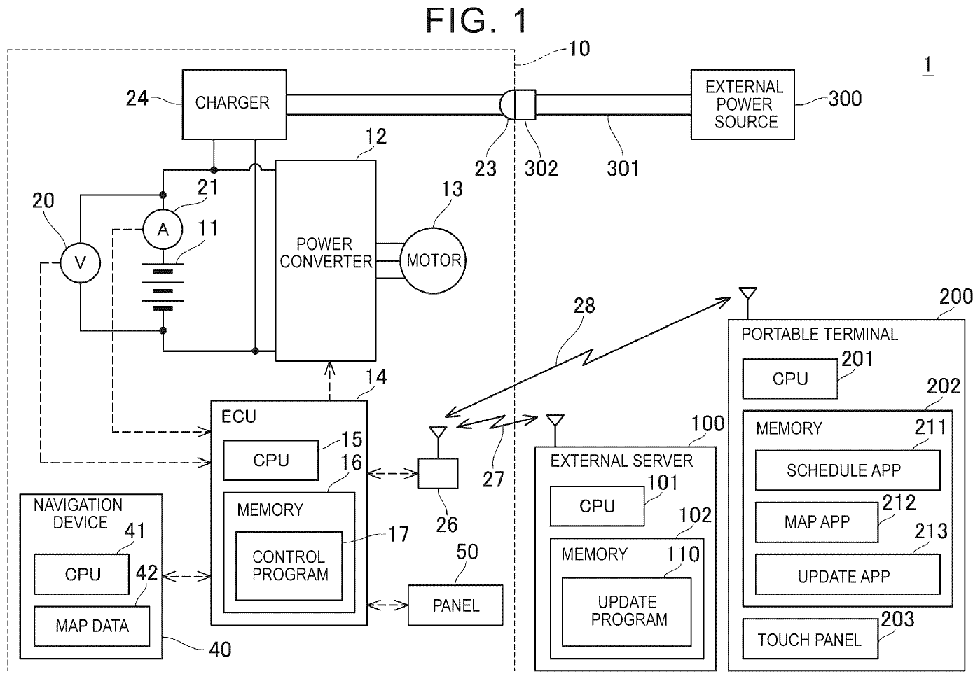

OTA device 1 illustrated in FIG. 1 mainly includes an electrified vehicle 10, an external server 100, a mobile terminal 200, and an external power source 300. The dotted line in FIG. 1 represents a signal line.

Electrified vehicle 10 mainly includes a battery 11, a power converter 12, a driving motor 13, an ECU 14, a voltage sensor 20, a current sensor 21, a charger 24, a charging socket 23, a data communication device 26, a navigation device 40, and a panel 50. The battery 11 is a rechargeable secondary battery, specifically, a lithium-ion battery. The power converter 12 converts the DC power of the battery 11 into the drive power (AC power) of the motor 13. The power converter 12 supplies drive power to the motor 13.

Electrified vehicle 10 can be powered by an external power source 300 via a charging socket 23 and a charger 24. A charging cable 301 is connected to the main body of the external power source 300. The charging cable 301 is provided with a connector 302 at its distal end. When the connector 302 is connected (plugged in) to the charging socket 23, electrified vehicle 10 is put into the plug-in status. Accordingly, the battery 11 can be plug-in charged.

ECU 14 includes CPU 15 and memories 16. The memory 16 stores a control program 17. In practice, a plurality of control programs 17 exist according to the respective functions. However, one control program 17 is described herein.

When CPU 15 executes the control program 17 stored in the memory 16, various kinds of control in ECU 14 are executed.

The current sensor 21 measures the charge/discharge current of the battery 11 and transmits the measurement data to ECU 14. The voltage sensor 20 measures the voltage of the battery 11 and transmits the measurement data to ECU 14. ECU 14 can determine State Of Charge (SOC) of the battery 11 using the charge/discharge current and the open-circuit voltage (Open Circuit Voltage (OCV)) of the battery 11.

The data communication device 26 communicates various types of data with the external server 100 via the wireless communication 27. The data communication device 26 communicates various types of data with the mobile terminal 200 via the short-range wireless communication 28. An example of short-range wireless communication 28 is Bluetooth (registered trademark).

The navigation device 40 includes CPU 41 and map-data 42. The navigation device 40 may use GPS to locate electrified vehicle 10. The navigation device 40 is configured to perform a route search for finding a travel route (for example, the shortest route) from the present position of electrified vehicle 10 to the destination, and display the travel route found by the route search on the panel 50.

The external server 100 is a server for causing the respective vehicles to execute the update by OTA. The external server 100 is communicably connected to each vehicle by wireless communication 27. The external server 100 includes CPU 101 and memories 102. The memory 102 stores an update program 110. The update program 110 is a program used to update the control program 17 stored in each vehicle. The update program 110 is registered in the memory 102 each time an update occurs in the control program 17. Each time a new update program 110 is stored, the external server 100 transmits an update notification to each vehicle via the wireless communication 27.

The update notification is information for requesting an update to the control program 17 stored in each vehicle. The update notification includes a priority flag. The priority flag is information indicating the level of urgency of the update. The level of the degree of urgency may be, for example, two levels of “high” and “low”, or may have a plurality of levels of three or more stages. The level of urgency can be predetermined by the update administrator or the user. For example, the update administrator may appropriately determine the level of the degree of urgency according to the contents of the update. The user may also instruct the external server 100 to increase the degree of urgency of an update regarding a function that the user wants to use.

The mobile terminal 200 is a device carried by a user of electrified vehicle 10. The mobile terminal 200 may be various devices. For example, a smart phone, a tablet terminal, a laptop PC, a wearable device (e.g., a smart watch), or the like can be used as the mobile terminal 200. In the present embodiment, a case where the mobile terminal 200 is a smartphone will be described.

The mobile terminal 200 mainly includes a CPU 201, a memory 202, and a touch panel 203. The memory 202 mainly stores a schedule application 211, a map application 212, and an update application 213. The schedule app 211 is an application that manages a schedule of a user. For example, the user can register the travel schedule (destination, departure time, arrival time, and the like) in the schedule app 211 in advance. The map application 212 is an application that navigates a route to a destination in conjunction with a GPS. The map application 212 can also search for an installation location of the external power source 300. The update application 213 is an application for executing an update process of the control program. Details of the update process will be described later.

### Update Process

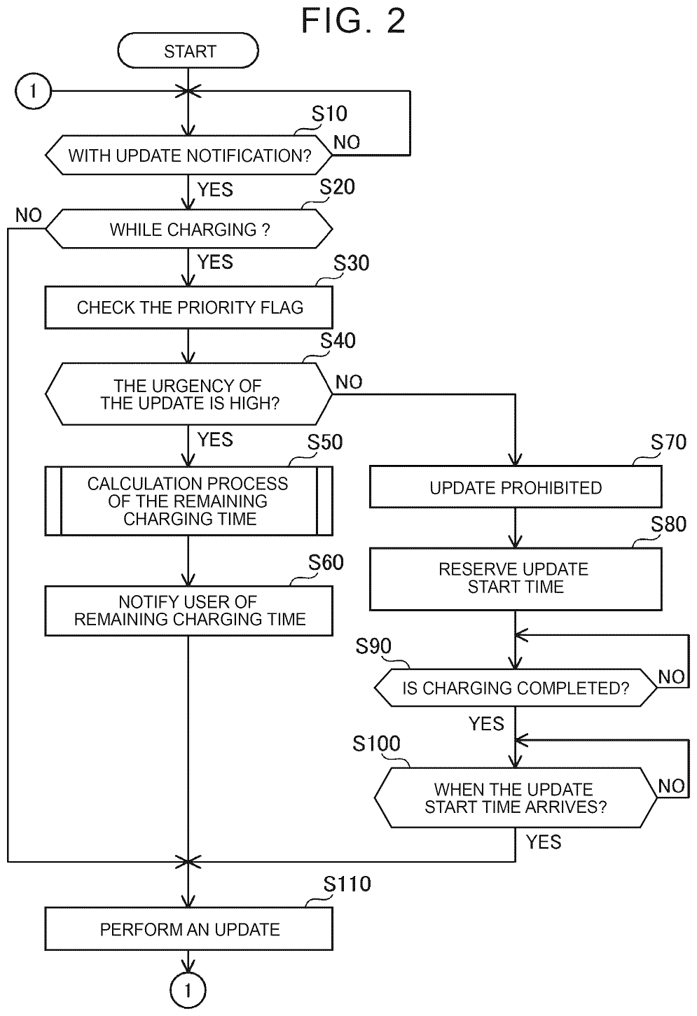

The contents of the update process will be described with reference to the flowchart of FIG. 2. In the present embodiment, a case where the mobile terminal 200 is a vehicle control device will be described. That is, a case where the mobile terminal 200 executes the update process will be described. Specifically, CPU 201 reads and executes the update application 213 from the memory 202 to execute the update process. The flowchart of FIG. 2 may be executed at all times while the mobile terminal 200 is communicably connected to electrified vehicle 10 by the short-range wireless communication 28. In the following description, “step 10” is abbreviated as “S10”.

In S10, CPU 201 of the mobile terminal 200 confirms the presence or absence of an update notification. CPU 201 monitors, via short-range wireless communication 28, whether electrified vehicle 10 has received an update notification from the external server 100. When the update notification is not received (S10: NO), the process waits, and when the update notification is received (S10: YES), the process proceeds to S20.

In S20, CPU 201 determines whether electrified vehicle 10 battery 11 is being charged. The method of determination may vary. For example, ECU 14 may be queried for charge status via short-range wireless communication 28.

If it is determined that S20 is not being charged (S20: NO), the process proceeds to S110. In S110, CPU 201 performs an update. Specifically, CPU 201 transmits an update instruction to ECU 14 via the short-range wireless communication 28. ECU 14 that has received the update instruction receives the update program 110 from the external server 100 via the wireless communication 27. ECU 14 executes the received update program 110 to update the control program 17. Then, return to S10.

On the other hand, when it is determined that S20 is being charged (S20: YES), the process proceeds to S30. In S30, CPU 201 checks the content of the prioritized flag included in the update notification. Specifically, CPU 201 receives an update notification from ECU 14 via the short-range wireless communication 28. Then, the priority flag in the update notification is read.

In S40, CPU 201 determines whether the update is urgent or not. CPU 201 determines that the urgency is higher if the level of urgency of the prioritization flag is higher than a predetermined low level range. In addition, when the level of the urgency of the priority flag is within the range of the predetermined low level, it is determined that the urgency is not high.

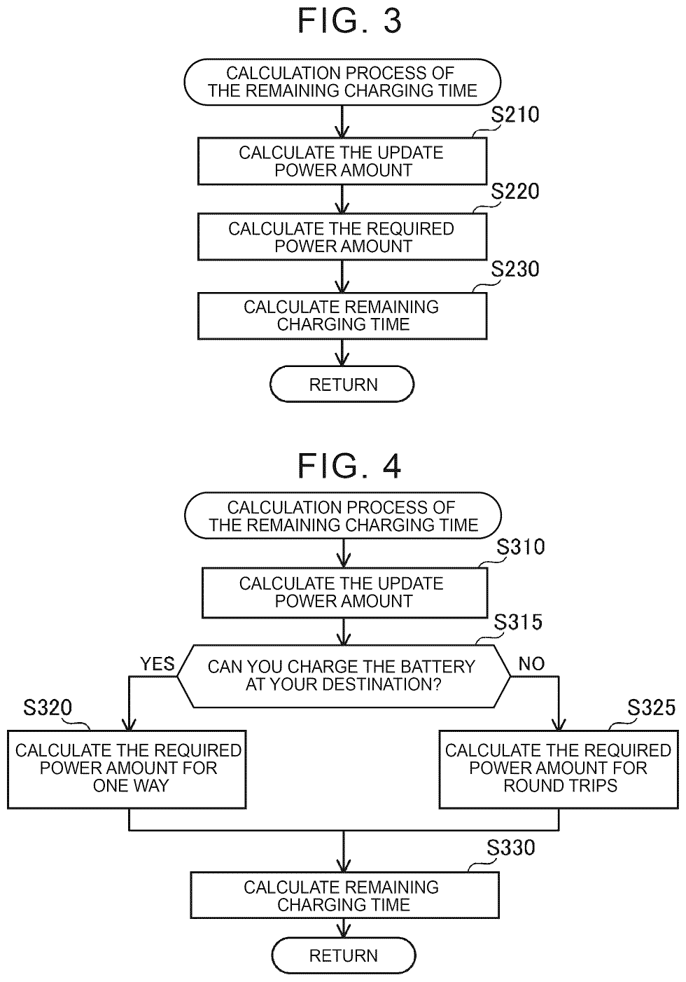

If it is determined that S40 is urgent (S40: YES), the process proceeds to S50. In S50, CPU 201 performs a process of calculating the remaining charging time. FIG. 3 illustrates an exemplary sub-routine process performed by S50.

In S210, CPU 201 calculates an update power amount. The update power amount is the power amount consumed by electrified vehicle 10 by the update. Various methods can be used to calculate the update power amount. For example, the update power amount may be calculated based on the estimated current amount and the estimated processing time in the update processing. The estimated processing time may be estimated from the data size of the update program. Further, for example, the update power amount may be set to a predetermined value.

In S220, CPU 201 calculates the required power amount. The required power amount is the required power amount to be stored in the battery 11 after the charging is completed. Various methods can be used to calculate the required power amount. For example, the required power amount may be calculated based on the required power amount for moving to the destination.

The required power amount to move to the destination can be calculated by various methods. For example, the update application 213 may be interlocked with the schedule application 211 and the map application 212. The update application 213 can read the destination from the movement schedule registered in the schedule app 211. Further, the update application 213 can calculate the traveling distance to the read destination using the map application 212. As a result, the update application 213 can automatically calculate the required power amount for moving to the destination.

In S230, CPU 201 calculates the remaining charging time. The remaining charging time is a time required for charging the battery 11 from the external power source 300 with the minimum charging power amount, which is the amount of power that needs to be minimally charged. The minimum charging power amount is obtained by subtracting the charged power amount at the time when the charging of the battery 11 is started from the total amount of the updated power amount and the required power amount. In other words, in order to move to the destination, the battery 11 needs to be charged with a charging time equal to or longer than the remaining charging time. Then, the process proceeds to S60 (FIG. 2).

In S60, CPU 201 notifies the user of the calculated remaining charging time. Various methods can be used for the notification method. For example, the remaining charging time may be displayed on the touch panel 203 of the mobile terminal 200. Also, for example, the remaining charging times may be displayed on electrified vehicle 10 50 via the short-range wireless communication 28. The display content may vary. For example, information such as “It takes XX minutes to charge YY % because the emergency software is being updated” may be displayed. Then, the process proceeds to S110 regardless of whether or not the charge is completed, and the update is executed. After the update is completed, the process returns to S10. Note that the content of S110 has already been described, and thus the explanation thereof is omitted here.

On the other hand, if it is determined in S40 that the urgency is not high (S40: NO), the process proceeds to S70. In S70, CPU 201 prohibits ECU 14 from performing the update during the charge. The prohibition process can be executed by various methods. In the present embodiment, the prohibition process is executed by waiting until the update start time arrives (S100: YES) to transmit the update instruction to ECU 14.

In S80, CPU 201 reserves the update-start-time. The update start time may be any time after charging is completed. This is because an update that is not very urgent has no problem even if the update is suspended. It is preferable that the update starting time is reserved in a time zone in which the user does not use electrified vehicle 10 or in a time zone in which the user is charging after the next time.

The update start time may be reserved in various manners. The update application 213 may automatically make a reservation. For example, the update application 213 may read electrified vehicle 10 non-use period from the schedule registered in the schedule application 211. The update start time may be set within the range of the non-use time period. Thus, the update can be executed at times when electrified vehicle 10 is not used. Further, for example, the update application 213 may read the parking position of electrified vehicle 10 in the non-use period of electrified vehicle 10 from the schedule application 211, and may read the presence or absence of the external power source 300 in the parking position from the map application 212. The update start time may be set in a time period in which the vehicle is stopped for a long time at the parking position where the external power source 300 is present. Thus, the update can be executed when there is a margin in the charge time, so that the full charge can be performed even when the update power amount is consumed.

In S90, CPU 201 determines whether or not the current charge is completed. This determination can be made, for example, based on the charge status transmitted from ECU 14 via the short-range wireless communication 28. When the charging is not completed (S90: NO), it stands by, and when the charging is completed (S90: YES), it proceeds to S100.

In S100, CPU 201 determines whether the reserved update-start-time has arrived. If it has arrived (S100: NO), it waits, and if it has arrived (S100: YES), it proceeds to S110. Updates are performed in S110. After the update is completed, the process returns to S10.

### Effects

The problem is described. Since the software update by OTA occurs irregularly, the update by OTA may occur while the battery 11 of electrified vehicle 10 is being charged. In this case, the power consumption due to the update increases. Then, for example, when the battery 11 is charged to a predetermined target SOC, the charging period becomes longer by the amount of power consumed by the update. The inadvertent prolongation of the charging time may cause a disadvantage to the user. Therefore, in the technique of the present specification, when an update by OTA occurs while the battery 11 is being charged, the urgency of the update can be determined (S40). Then, when the urgency is not high (S40: NO), it is possible to prohibit the update from being executed during the charge (S70). That is, the update start timing can be optimized according to the urgency. This makes it possible to suppress a situation in which the charging time becomes longer than in the case where the update is executed during the charging.

In the technique of the present specification, the remaining charging time, which is the minimum required charge time, can be calculated based on the updated power amount and the required power amount for traveling to the destination (S230). Then, the calculated remaining charging time can be notified to the user (S60). This makes it possible to prompt the user to optimize the charging time. (Example: If the battery is suddenly charged, start immediately after the remaining charging time has elapsed. If there is a margin, charge the battery for a longer time than the remaining charging time.)

### Example 2

In the second embodiment, a second mode of a process (S50) for calculating the remaining charging time will be described. In the second embodiment, only a part different from the first embodiment will be described. FIG. 4 illustrates an example of a subroutine process performed by S50 according to the second embodiment.

In S310, CPU 201 calculates an update power amount. The content of S310 is the same as that of the above-described S210, and therefore will not be described.

In S315, CPU 201 determines whether the battery can be charged at the destination. The determination can be performed in a variety of ways. For example, the update application 213 may be interlocked with the schedule application 211 and the map application 212. The update application 213 can read the departure time, the destination, the stay time at the destination, and the like from the travel schedule registered in the schedule app 211. Further, the update application 213 can acquire the traveling distance to the read destination and the presence or absence of the external power source 300 at the destination by using the map application 212. When the external power source 300 is present at the destination and the stay time at the destination is equal to or longer than a predetermined time, the update application 213 can determine that charging at the destination is possible.

If it is determined in S315 that charge at the destination is available (S315: YES), the process proceeds to S320. In S320, CPU 201 calculates the required power amount based on the required power amount to move one way to the destination. This is because the power required for the return can be charged at the destination. Then, proceed to S330.

On the other hand, when it is determined in S315 that the charge at the destination is not possible (S315: NO), the process proceeds to S325. In S325, CPU 201 calculates the required electric power amount based on the electric required power amount for traveling back and forth to the destination. This is because the electric power required for the forward path and the return path needs to be charged at the present time. Then, proceed to S330.

In S330, CPU 201 calculates the remaining charging time. The content of S330 is the same as that of the above-described S230, and therefore will not be described. Then, the process proceeds to S60 (FIG. 2).

In S60, CPU 201 notifies the user of the calculated remaining charging time. At this time, when the departure time is known, the charge amount in the case of charging up to the departure time may be notified together. For example, “The battery needs to be charged for at least XX. You can charge up to YY %. The battery can be charged up to XX % by adding YY minutes to the departure time.” Such information may be displayed. It should be noted that the charge may be presented as a percentage of SOC or as a cruising range.

Although the embodiments have been described in detail above, the embodiments are merely examples and do not limit the scope of claims. The techniques described in the claims include various modifications and alterations of the specific examples illustrated above. The technical elements described in this specification or in the drawings may be used alone or in various combinations, and are not limited to the combinations described in the claims at the time of filing. Further, the technology illustrated in the present specification or the drawings achieves a plurality of objects at the same time, and has technical usefulness by achieving one of the objects.

### Modifications

The vehicle control device that executes the update process is not limited to the mobile terminal 200, and may be various. For example, the external server 100 may be a vehicle control device. CPU 101 of the external server 100 reads the update application from the memory 102 and executes the update application, thereby executing the update process. Further, for example, ECU 14 of electrified vehicle 10 itself may function as a vehicle control device. In this case, CPU 15 of ECU 14 reads the update application from the memory 16 and executes the update application, whereby the update process can be executed.

In S40, the method of determining the urgency of the update is not limited to the method of using the flag, and may be various. For example, a method of inquiring the external server 100 about the urgency may be used.

The method of executing S70 prohibition process is not limited to the method using the update starting time. For example, S80 may be skipped and, in response to completion of the charge in S90, proceed to S110 to immediately perform the update. Also, for example, in S70, an instruction to wait for a predetermined period of update may be transmitted to ECU 14.

The method of connecting the mobile terminal 200 and electrified vehicle 10 is not limited to the method via the short-range wireless communication 28. For example, it may be a wired connection.

Instead of the map application 212 provided in the mobile terminal 200, a navigation device 40 mounted on electrified vehicle 10 may be used.

What is claimed is:

1. A vehicle control device for controlling a vehicle, the vehicle being a vehicle that includes a battery that is chargeable using an external power source, a communication unit that is communicable with an external server regarding various types of data by wireless communication, and an electronic control unit (ECU) that executes various types of control based on a control program stored in advance, wherein:
the vehicle control device is configured to execute processing of detecting a request for update with respect to the control program, from the external server to the ECU, during charging of the battery by the external power source; and
the vehicle control device is configured to execute processing of prohibiting the ECU from executing the update during the charging, at least in part of situations in which the request for updating is detected.

2. The vehicle control device according to claim 1, wherein, in the processing of prohibiting the ECU from executing the update, execution of the update is prohibited when a degree of urgency of the update is within a predetermined low level range.

3. The vehicle control device according to claim 2, wherein:
the vehicle control device is further configured to, when executing the update during the charging, execute processing of calculating an update power amount that is consumed by the vehicle due to the update, and a required power amount that will be required for the battery thereafter;
the vehicle control device is configured to further execute processing of calculating a remaining charging time required for charging the battery from the external power source, with a power amount obtained by subtracting a charged power amount at a point in time of starting charging of the battery from a total amount of the update power amount and the required power amount; and
the vehicle control device is configured to further execute processing of notifying a user of the remaining charging time that is calculated.

4. The vehicle control device according to claim 3, wherein the required power amount is a required power amount for traveling to a destination.

5. The vehicle control device according to claim 4, wherein:
the vehicle control device is configured to determine whether the battery is chargeable at the destination when executing the update during the charging;
the vehicle control device is configured to calculate the required power amount for one way to the destination when determination is made that the battery is chargeable at the destination; and
the vehicle control device is configured to, when determination is made that the battery is not chargeable at the destination, calculate the required power amount for a round trip to the destination.
